(19) United States
(12) Patent Application Publication
(10) Pub. No.: US 2014/0155112 A1
(43) Pub. Date: Jun. 5, 2014

(54) SUPPORT OF SHORT MESSAGE SERVICE IN IMS WITHOUT MSISDN

(71) Applicants: Attila Molnar, God (HU); Andras Pasztor, Budapest (HU)

(72) Inventors: Attila Molnar, God (HU); Andras Pasztor, Budapest (HU)

(73) Assignee: NOKIA SOLUTIONS AND NETWORKS OY, Espoo (FI)

(21) Appl. No.: 14/131,217

(22) PCT Filed: Jul. 5, 2011
(86) PCT No.: PCT/EP2011/061318

§ 371 Date: Feb. 19, 2014

(51) Int. Cl. H04W 4/14

(52) U.S. Cl. CPC H04W 4/14
USPC 455/466

(57) ABSTRACT

The application relates to Short Message Service SMS in IMS. The relevant standard is 3GPP TR 23.863. According to current standardised procedures, a UE in an originating network can submit an encapsulated SMS to an S-CSCF which forwards it to an IP-SM-GW in the originating network. The IP-SM-GW can extract the SMS and forward it to an SMS-SC. The SMS-SC can forward the SMS to an SMS-GMSC in the terminating network which delivers it to an IP-SM-GW in the terminating network. The can use the telephone uniform resource identifier associated with the IMSI of the message received for the target UE to send the short message encapsulated in the appropriate SIP method towards an S-CSCF which forwards it to the target UE. If the target UE is available via IMS forwarding via the SMS-SC is unnecessary. Therefore, the present application proposes to deliver a SIP message (S16) with encapsulated SMS content from the IP-SM-GW (300) in the originating network directly to an IP-SM-GW (500) in the terminating network without the usage of the SMS-SC.

### FIELD OF THE INVENTION

The present invention generally relates to telecommunications. For example, the present invention can relate to Internet Protocol (IP) networks. In certain embodiments, the present invention specifically relates to Short Message Service (SMS) over IP networks.

### BACKGROUND ART

Communication can occur in wireless communication networks and systems, such as Third Generation Partnership Project (3GPP), wherein SMS messages are sent from one user terminal to another user terminal. SMS messages are typically sent over networks operating on a communication protocols such as IP. The SMS can be terminated in the IP multimedia subsystem (IMS), and utilize Session Initiation Protocol (SIP) for initiating and controlling service request. The specifications of such SIP protocol details can be found, for example, in 3GPP Technical Specification TS 24.229, e.g. v10.3.0 (04-2011). The functionality of SMS over IP is defined in 3GPP TS 23.204, e.g. v10.2.0 (09-2010) and 24.341, e.g. v10.0.0 (03-2011). General SMS functionality and related mobile application part (MAP) signaling is described, for example, in 3GPP TS 23.040, e.g. v10.0.0 (04-2011), TS 23.140, e.g. v6.16.0 (03-2009), and TS 24.011, e.g. v10.0.0 (03-2011).

However, there are certain disadvantages in the procedures according to the current specifications. For example, in case the terminating party/subscriber/user equipment (UE) is available via any of the circuit switched (CS)/packet switched (PS)/IMS domains, unnecessary reports and/or messages are sent between short messaging service network elements, such as IP-Short-Message-Gateway (IP-SM-GW), SMS interworking mobile services switching centre (SMS-IWMSC)/gateway mobile services switching centre (MSC) for short message service (SMS-GMSC) and/or SMS Service Centre (SMS-SC) thus causing extra load to the core network and to the mentioned network elements.

### SUMMARY

It is therefore an object of this invention to address some of the above mentioned problems by providing a method, apparatuses, a system and a computer program product for direct message delivery mechanism for short messages over IP.

A method, an apparatus, a system and a computer program product, are provided, comprising receiving at a first messaging gateway in a first network a user message over internet protocol to be delivered to a second user equipment in a second network, and forwarding by said first messaging gateway the user message to a second messaging gateway in the second network.

The user message can comprise a short message service (SMS) message, for example, according to the GSM.

The forwarding the user message can comprise forwarding directly from said first messaging gateway to said second messaging gateway.

The method, apparatus, system and computer program product can comprise checking by the first messaging gateway if a direct delivery attempt should be performed.

The method, apparatus, system and computer program product can comprise interrogating a subscriber database in the second network to retrieve routing information for said second user equipment in the second network.

The subscriber database can comprise a home location register or a home subscriber server.

The method, apparatus, system and computer program product can comprise receiving at least one of an address and a correlation id of said second messaging gateway in response to said interrogating.

The receiving at least one of an address and a correlation id of said second messaging gateway can comprise receiving from said second messaging gateway.

The forwarding the user message to said second messaging gateway can comprise forwarding the user message together with the received correlation id.

The method, apparatus, system and computer program product can comprise converting type of the user message before forwarding it to the second messaging gateway, for example, the user message is converted from SMS-SUBMIT to SMS-DELIVER before forwarding it to the second messaging gateway.

The forwarding the user message to said second messaging gateway can comprise forwarding the user message comprising a flag indicating that a short message service centre is not used.

The forwarding the user message to said second messaging gateway can comprise forwarding the user message comprising a flag indicating that no alert service centre request should be sent based on the user message delivery.

The flag can comprise a noAlertSC flag.

The receiving and/or forwarding said user message can comprise receiving and/or forwarding a mobile application part based short message service message.

The receiving and/or forwarding a mobile application part based short message service message can comprise receiving and/or forwarding a MAP FORWARD-SHORT-MESSAGE.

The receiving and/or forwarding said user message can comprise receiving and/or forwarding a user message encapsulated in a session initiation protocol message.

The receiving and/or forwarding (S4) said user message can comprise receiving and/or forwarding a user message encapsulated in a SMS-SUBMIT message.

The receiving said user message can comprise receiving from a serving network element serving a first user equipment in the first network.

The serving network element can comprise a serving call session control function.

The method, apparatus, system and computer program product can comprise sending a submit report to the serving network element.

The sending the submit report can comprise sending a submit report encapsulated in a session initiation protocol request.

The method, apparatus, system and computer program product can comprise receiving an acknowledgement for session initiation protocol request.

The first messaging gateway can comprise an internet protocol short message gateway in the first network.

The second messaging gateway can comprise an internet protocol short message gateway in the second network.

A method, an apparatus, a system and a computer program product, are provided, comprising receiving at a second messaging gateway in a second network a user message to be delivered to a second user equipment in the second network, wherein the user message is received directly from a first message gateway in a first network.

The method, apparatus, system and computer program product can comprise, before receiving the user message, creating a correlation id of said second messaging gateway.

The method, apparatus, system and computer program product can comprise, before receiving the user message, sending at least one of an address and a correlation id of said second messaging gateway to said first messaging gateway.

The method, apparatus, system and computer program product can comprise forwarding the user message to a serving network element serving the second user equipment in the second network.

The serving network element can comprise a serving call session control function.

The receiving a user message can comprise receiving a user message including a flag indicating that a short message service centre is not used.

The receiving a user message can comprise receiving a user message including a flag indicating that no alert service centre request should be sent based on the user message delivery.

The flag can comprise a noAlertSC flag.

The receiving a user message can comprise receiving a mobile application part based short message service message.

The receiving a mobile application part based short message service message can comprise receiving a MAP FORWARD-SHORT-MESSAGE.

The receiving a user message can comprise receiving a user message encapsulated in a session initiation protocol message.

The receiving a user message can comprise receiving a user message encapsulated in a SMS-DELIVER message.

The first messaging gateway can comprise an internet protocol short message gateway in the first network.

The second messaging gateway can comprise an internet protocol short message gateway in the second network.

Embodiments of the present invention may have one or more of following advantages:
No need to submit short messages from IP-SM-GW to SMS-SC
No need to store short messages in SMS-SC
No need to deliver short messages from SMS-SC to SMS-GMSC
More effective procedures from the MAP signalling, SMS-SC resource and capacity, SMS-IWMSC/SMS-GMSC, and IP-SM-GW resources point of view
More efficient and more optimal use of network resources
Lower operating costs

### BRIEF DESCRIPTION OF DRAWINGS

FIG. 1 shows a simplified block diagram illustrating elements used for providing SMS over a generic IP connectivity access network.

FIG. 2 illustrates current procedures of successful encapsulated short message origination in case of transport-level interworking, according to 3GPP specifications.

FIG. 3 illustrates current procedures of successful encapsulated short message termination in case of transport-level interworking, according to 3GPP specifications.

FIG. 4 illustrates current procedures of handling the delivery report in case of transport-level interworking, according to 3GPP specifications.

FIGS. 5a and 5b illustrate a method a successful direct delivery/first delivery attempt of an originating encapsulated short message in case of transport-level interworking, according to some embodiments of the invention.

FIG. 6 illustrates an unsuccessful direct delivery/first delivery attempt of an originating encapsulated short message in case of transport-level interworking, according to some embodiments of the invention.

FIG. 7 illustrates a method (in a first short message gateway) according to some embodiments of the invention.

FIG. 8 illustrates a method (in a first short message gateway) according to some further embodiments of the invention.

FIG. 9 illustrates a method (in a second short message gateway) according to some embodiments of the invention.

FIG. 10 illustrates a method (in a second short message gateway) according to some further embodiments of the invention.

FIG. 11 illustrates an apparatus in a first network according to some embodiments of the invention.

FIG. 12 illustrates an apparatus in a first network according to some further embodiments of the invention.

FIG. 13 illustrates an apparatus in a second network according to some embodiments of the invention.

FIG. 14 illustrates an apparatus in a second network according to some further embodiments of the invention.

### DETAILED DESCRIPTION OF SOME EMBODIMENTS

Exemplary embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

The present invention is applicable to any node for any communication system or any combination of different communication systems that support a messaging service. The communication system may be a wireline communication system or a wireless communication system or a communication system utilizing both wireline networks and wireless networks. The messaging service may apply to different types of messages, for example, text messages, multimedia messages, e-mail messages, paging messages and fax messages. The protocols and specifications of communication systems, servers and user terminals, especially in wireless communication, develop rapidly. Such development may require additional changes to an embodiment. Therefore, all words and expressions should be interpreted broadly and they are intended to illustrate, not to restrict, the embodiment.

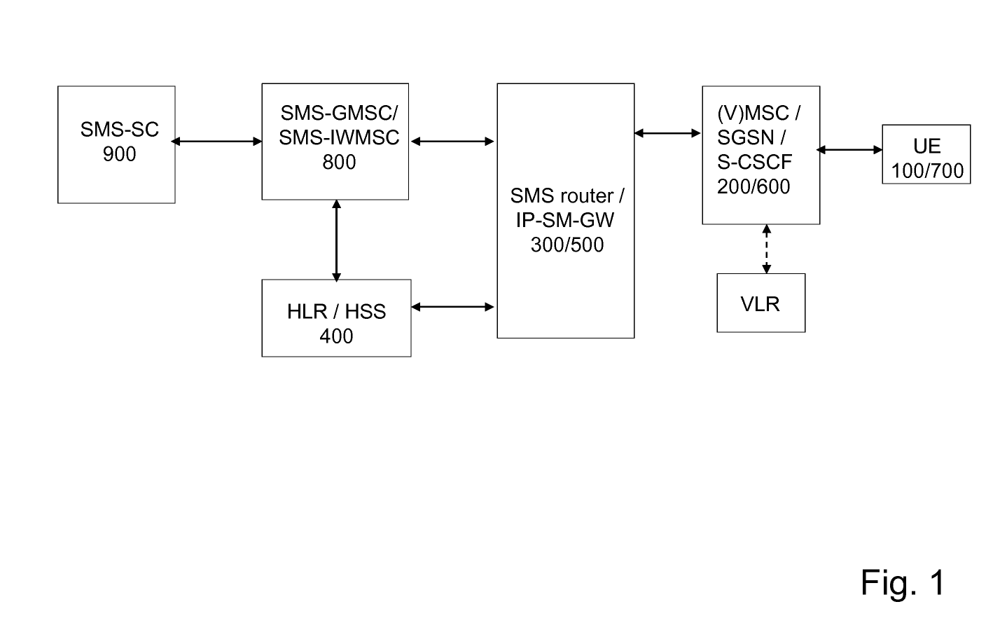

FIG. 1 shows a simplified block diagram illustrating elements used for providing SMS over a generic IP connectivity access network (IP-CAN).

SMS service centre (SMS-SC) 900 is a function responsible for relaying and store-and-forwarding of a short message. The SMS-SC is not a part of the Global System for Mobile Communications (GSM)/Universal Mobile Telecommunications System (UMTS) Public Land Mobile Network (PLMN); however MSC and SC may be integrated.

Gateway mobile services switching centre (MSC) for short message service (SMS-GMSC) 800 is a function of an MSC capable of receiving a short message from an SMS-SC 900, interrogating a home location register (HLR)/home subscriber server (HSS) 400 for routing information and SMS info, and delivering the short message to the next node on the route to the recipient user equipment (UE) 100/700. HLR/HSS 400 is a central database that contains details of each mobile phone subscriber that is authorized to use the GSM/UMTS/IMS core network.

SMS Router/IP-Short-Message-Gateway (IP-SM-GW) 300/500 is an element performing a domain selection in order to decide on the further route of the short message, delivering the short message to visited MSC (VMSC)/serving general packet radio service (GPRS) support node (SGSN)/serving call state control function (S-CSCF) 200/600 and returning a (positive/negative) delivery response to the SMS-GMSC 800. IP-SM-GW 300/500 is a function also responsible for protocol interworking between the IP-based UE 100/700 and the SMS-SC 900.

An IP-SM-GW can include an enhanced SMS router which is able to select among three domains (SIP/IMS, CS and PS). An SMS router can be able to select only CS and PS domains, but not supporting function towards IMS and SIP domains. One role of the IP-SM-GW can be the domain selection for IMS/SMSIP users and another role can be the protocol interworking.

VMSC/SGSN/S-CSCF 200/600 is a control function which performs signaling functions for mobile stations currently served by the MSC/SGSN/S-CSCF. Visitor location register (VLR) is a database in GSM system storing information about all the UEs/MSs that are currently under the jurisdiction of the MSC which it serves and it is interrogated by VMSC.

A mobile station (MS)/a user equipment (UE) 100/700, represents here a mobile device that a subscriber is using. Together with the software, applications, and content that are directly related to it, the device can function within and is supported by mobile infrastructure of the applied communications network. For short message service support the UE is configured to communicate via the communications system with a short message service centre SMS-SC and can exchange short message transfer protocol data units (SMS PDUs) with it.

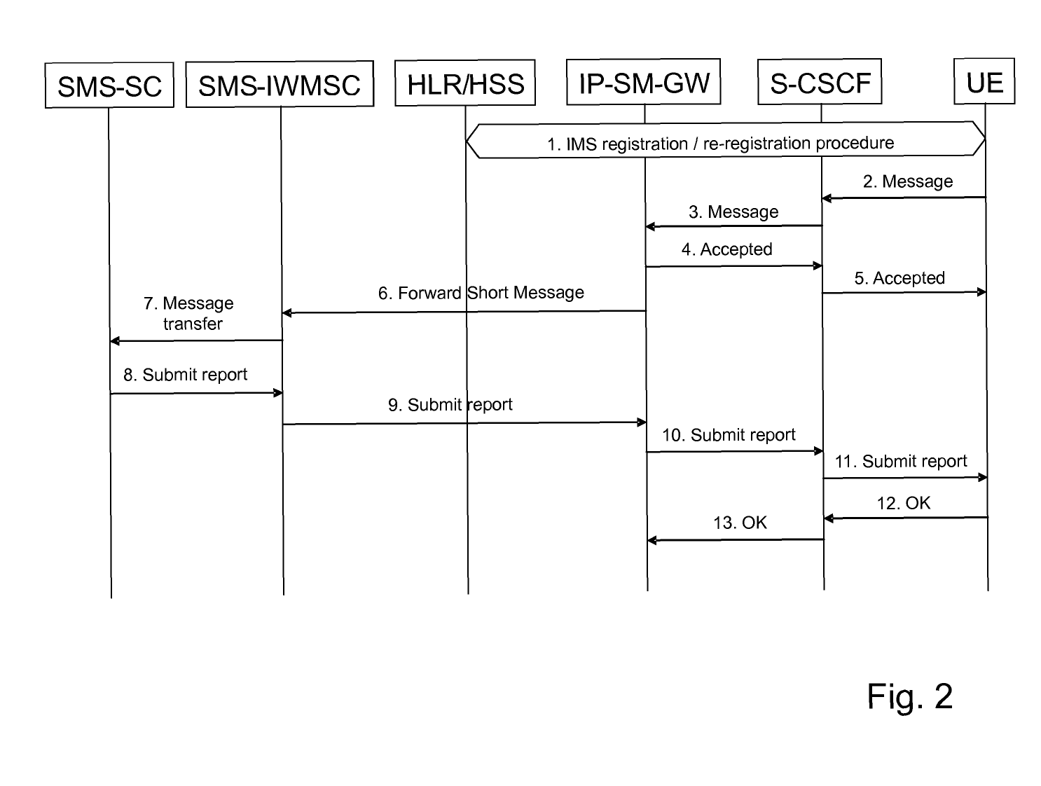

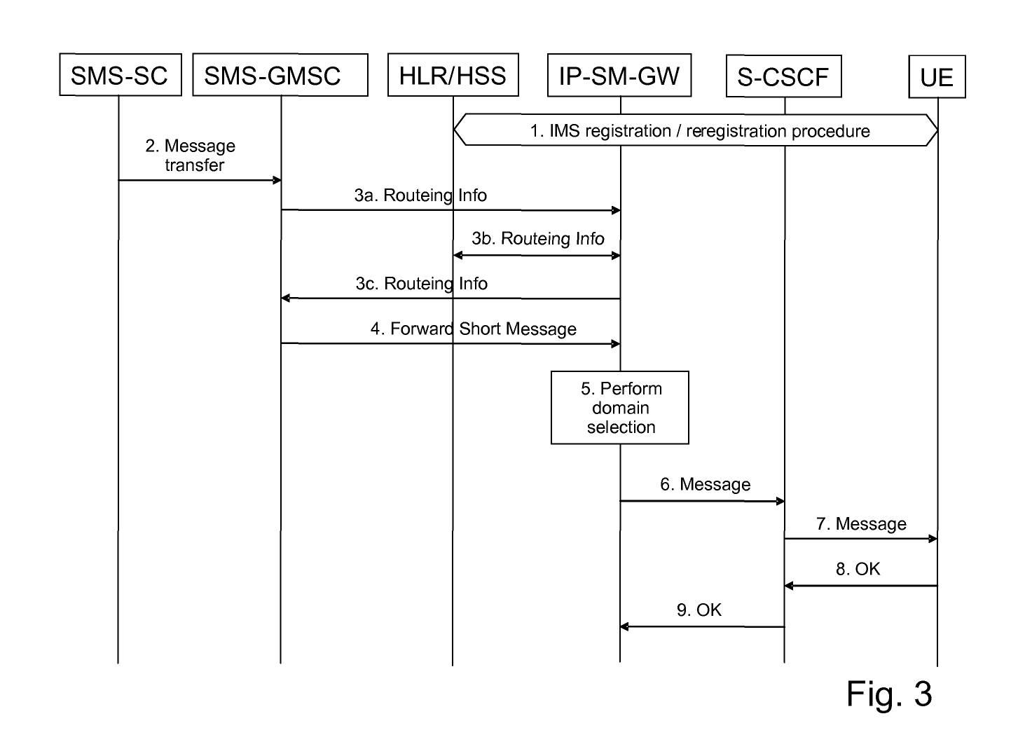

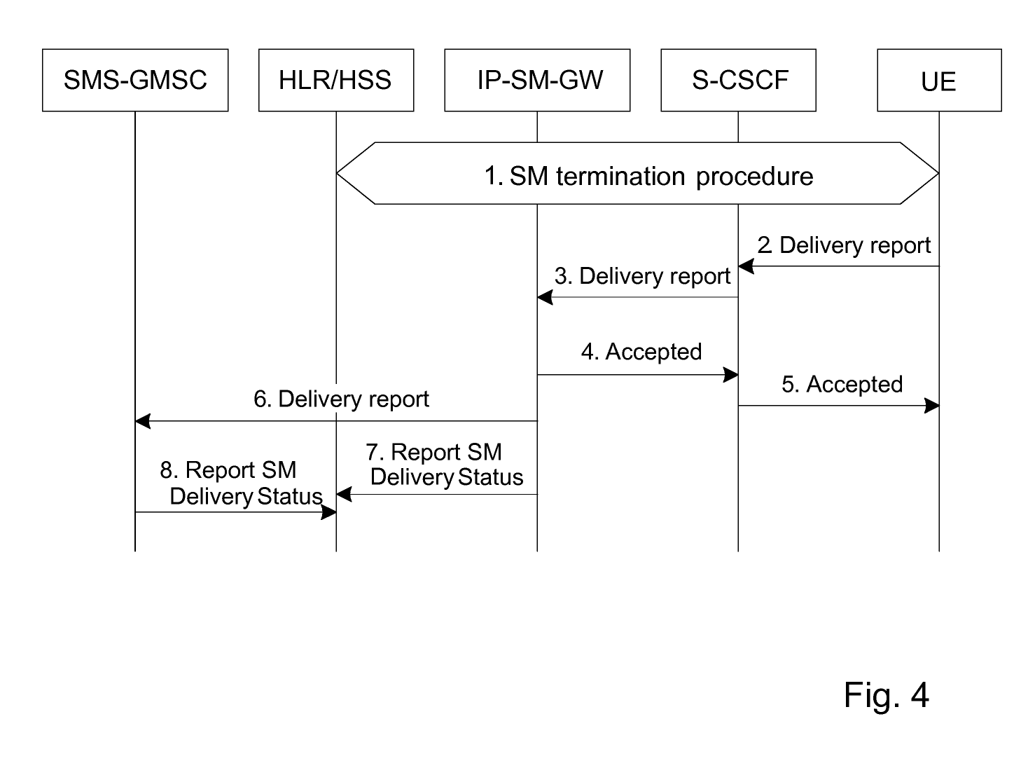

Current procedures of successful encapsulated short message transfer in case of transport-level interworking, according to 3GPP specifications, are shown in FIG. 2, FIG. 3 and FIG. 4. FIG. 2 illustrates current successful encapsulated short message origination procedure, FIG. 3 illustrates current successful encapsulated short message termination procedure and FIG. 4 illustrates current delivery report procedure.

According to the current procedures (FIG. 2), a UE in the originating network can submit an encapsulated Short Message (SMS-SUBMIT, SC Address) to an S-CSCF and the S-CSCF can then forward the encapsulated Short Message to an IP-SM-GW. The IP-SM-GW can perform service authorization based on the stored subscriber data, e.g. the IP-SM-GW can check whether the user is authorized to use the encapsulated Short Message delivery via IMS. If the result of service authorization is positive, the IP-SM-GW can extract the Short Message (SMS-SUBMIT) and can forward it towards an SMS-SC (SC Address) via an SMS-IWMSC using standard MAP signaling. SMS-SC can send a Submit report (SMS-SUBMIT REPORT) to SMS-IWMSC and the SMS-IWMSC can send the Submit report to IP-SM-GW.

The SMS-SC can forward the Short Message (SMS-DELIVER) to an SMS-GMSC in the terminating network (FIG. 3). The SMS-GMSC can interrogate an HSS to retrieve routing information. Based on the pre-configured IP-SM-GW address for the user, the HSS can forward the request to the corresponding IP-SM-GW. The HLR/HSS can return the addresses of the current MSC, SGSN to the IP-SM-GW for delivery of the Short Message in CS/PS domain. The IP-SM-GW can return only one address, which is of itself, along to the SMS-GMSC. The SMS-GMSC can deliver the Short Message (SMS-DELIVER) to IP-SM-GW. The IP-SM-GW can perform service authorization based on the stored subscriber data, e.g can check whether the terminating subscriber is authorized to use the encapsulated Short Message delivery via IMS. If the result of service authorization is positive, the IP-SM-GW can perform domain selection function to determine the preferred domain for delivering the message according to operator policy and user preferences. If the preferred domain is IMS, the IP-SM-GW can use the telephone uniform resource identifier (TEL-URI) associated with the international mobile subscriber identity (IMSI) of the message received for the target UE to send the short message (SMS DELIVER, SC Address) encapsulated in the appropriate SIP method towards the S-CSCF. The S-CSCF can forward the encapsulated Short Message (SMS-DELIVER, SC Address) to the UE.

When the UE has received the Short Message, it can send a Delivery report (SMS-DELIVER REPORT) to the S-CSCF (FIG. 4). The S-CSCF can forward the Delivery report to the IP-SM-GW (AS). The IP-SM-GW (AS) can send a Delivery report to the SMS-GMSC.

In case of B party is available via any of the CS/PS/IMS domains the above described SM forwarding and the submit reports between IP-SM-GW, SMS-IWMSC and SMS-SC as well as the SM forwarding and delivery reports between SMS-SC, SMS-GMSC and IP-SM-GW are unnecessary and can cause extra load to the core network, SMS-SC and IP-SM-GW. The inventive methods of the present invention can provide simplified procedures where the unnecessary messages and extra load may be avoided. The present invention is to provide a way of delivering SIP MESSAGEs with encapsulated SMS content received by IP-SM-GW directly to the B party without the usage of the SMS-SC.

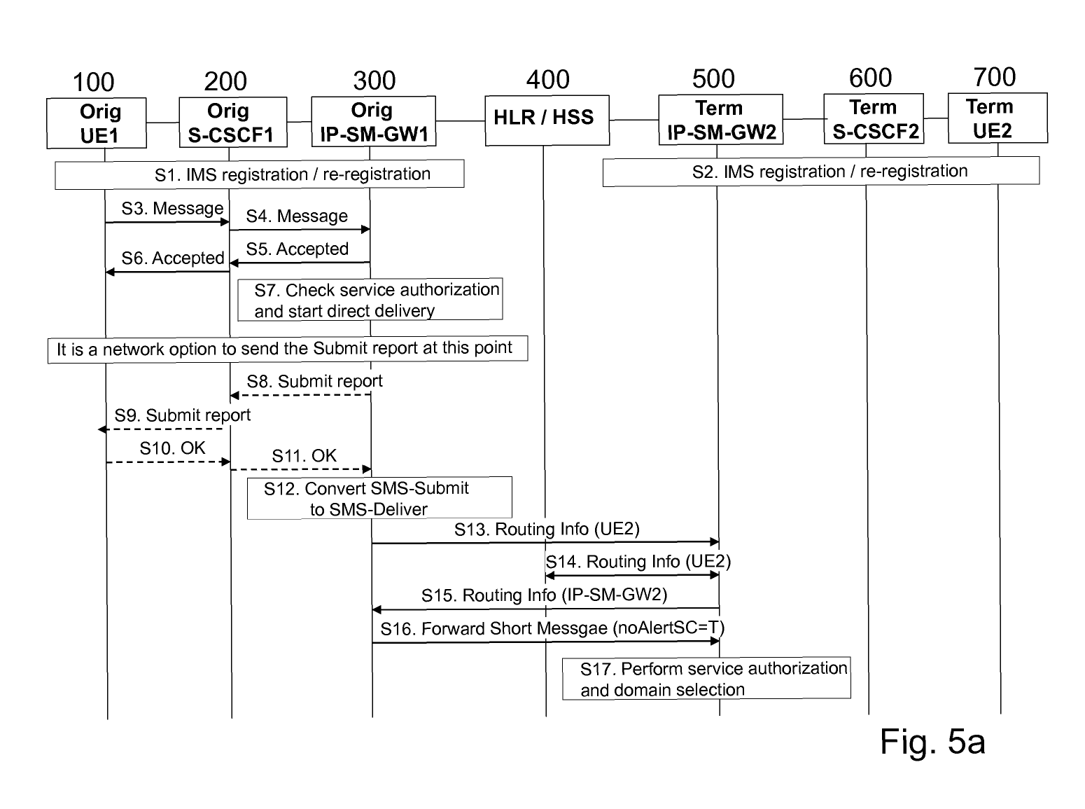

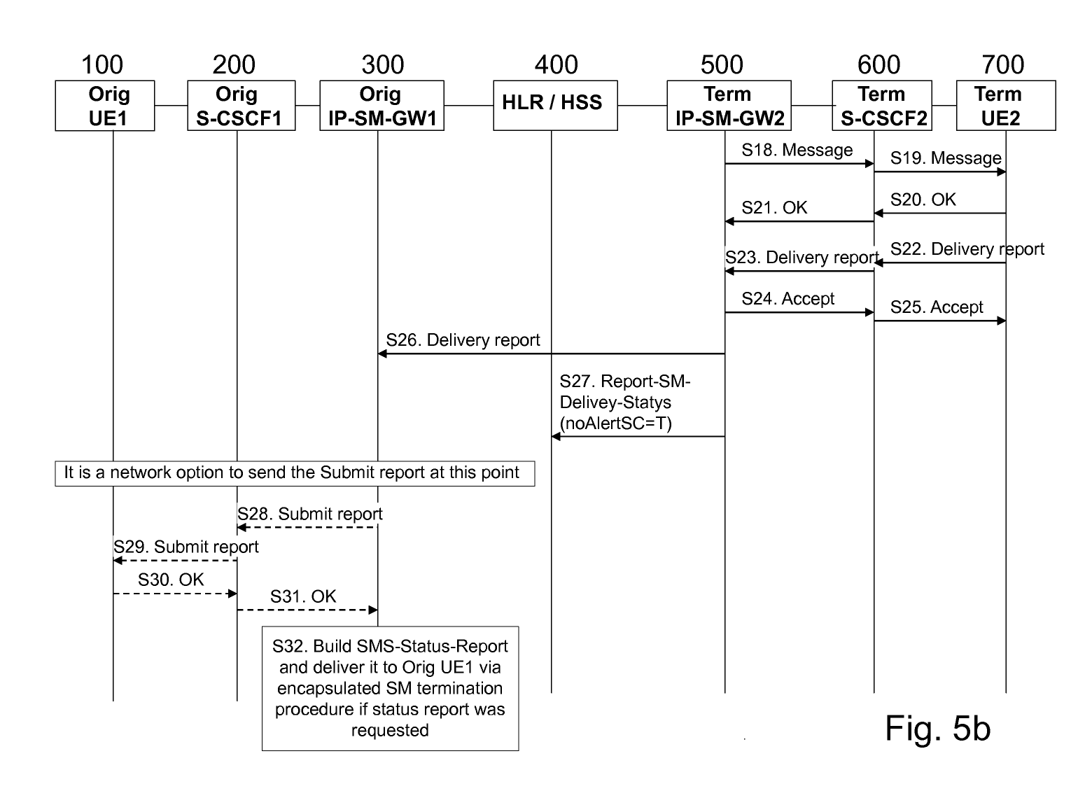

The method for delivering of an encapsulated SMS received by IP-SM-GW according to some embodiments of the present invention is shown in FIGS. 5a and 5b. In the method, at least some of the following steps may be performed:

S1) An originating UE1 100 may register to own S-CSCF 200 in the originating network according to normal IMS registration procedures. (For the sake of simplicity, I-CSCFs and P-CSCFs are not shown in the figures).

S2) A terminating UE2 700 may register to own S-CSCF 600 in the terminating network according to normal IMS registration procedures. (For the sake of simplicity, I-CSCFs and P-CSCFs are not shown in the figures).

S3) The originating UE1 100 may submit an encapsulated short message (SMS-SUBMIT, SC Address) to the S-CSCF 200 using a suitable SIP method.

S4) The S-CSCF 200 of the originating UE1 100 may forward the encapsulated short message (SMS-SUBMIT, SC Address) to an IP-SM-GW 300 of the subscriber based on the initial filter criteria (iFC) stored in the HSS serving the subscriber of the UE1 100. The originating IP-SM-GW 300 may receive the short message. (Subscribers who have no subscription for transport level interworking may be provided with the relevant iFCs, to provide SMS filtering/blocking.)

S5) The originating IP-SM-GW 300 may acknowledge the SIP message.

S6) The SIP message acknowledge may be forwarded by the S-CSCF 200 to the originating UE1 100.

S7) The IP-SM-GW 300 may perform originating service authorization based on the stored subscriber data. The IP-SM-GW 300 may check whether the subscriber is authorized to use the short message service (e.g. operator determined barring settings), similar to the authorization performed by an MSC/SGSN in case the short message is transferred via CS or PS domain. In addition, the IP-SM-GW 300 may also check whether the user is authorized to use the encapsulated short message delivery via IMS. If the result of service authorization is negative, the IP-SM-GW 300 may not forward the message, and may return the appropriate error information to the UE 100 in a failure report. The IP-SM-GW 300 may also check whether a direct/first delivery attempt should be performed for the user or not. If the result is negative then the normal procedure may be executed (see FIG. 2), the IP-SM-GW 300 may extract the short message (SMS-SUBMIT) and forward it towards an SMS-SC 900 (SC Address) via an SMS-IWMSC 800 using standard MAP signaling. Otherwise, the IP-SM-GW 300 may start the direct/first delivery attempt procedure as follows.

S8) At this point, according to operator policies, the originating IP-SM-GW 300 may send a Submit report to the S-CSCF 200, encapsulated in an appropriate SIP request.

S9) The S-CSCF 200 may send the Submit report encapsulated in the SIP request to the originating UE 100.

S10) The UE 100 may acknowledge the SIP request.

S11) The S-CSCF 200 of the originating subscriber may forward the acknowledgement of the SIP request to the IP-SM-GW 300 of the subscriber.

Steps S8-S11 may be conditional. Due to timer issues, in case of direct delivery service, it may be possible to control by the operator when the Submit report is sent to the originating UE1 100.

S12) The originating IP-SM-GW 300 may convert the received SMS-SUBMIT to SMS-DELIVER short message type. The TP-Reply-Path field located within the first octet of the SMS-DELIVER PDU may be set to value 0 (meaning that a reply path does not exist, so that the replying MS/short message entity (SME) may set the RP-Destination-Address in RP-MO-DATA to the selected SC or a default SC and not to the received one).

S13) The originating IP-SM-GW 300 may interrogate the HLR/HSS 400 in the terminating network to retrieve routing information of the terminating UE2 700.

The Send-Routing-Info-for-SM-request may not be forwarded if it has been sent originally from an IP-SM-GW 300. Therefore the originating IP-SM-GW 300 may use a virtual GMSC Global Title (GT) address for the routing information interrogation that is not handled by the HLRs/HSSs as an IP-SM-GW address. Based on the pre-configured or registered IP-SM-GW address for the terminating UE2 700, the HSS 400 may forward the request to the corresponding IP-SM-GW 500 of the terminating network.

If there is only a single IP-SM-GW 500, the IP-SM-GW address does not need to be pre-configured or registered in the HSS 400, and the Send-Routing-Info-for-SM-request may be forwarded on the signalling transfer point (STP) level.

S14) The terminating IP-SM-GW 500 may interrogate the HLR/HSS 400 in the terminating network to retrieve routing information. The HLR/HSS 400 may return the addresses of the current MSC and/or SGSN to the terminating IP-SM-GW 500 for delivery of the short message in CS/PS domain. The HLR/HSS 400 may also return the IMSI, for the IP-SM-GW 500 to correlate the receipt of Short Message from the mobile terminated (MT) Correlation ID within the IMSI field of the Forward-Short-Message.

S15) The IP-SM-GW 500 may create a MT Correlation ID as per TS 23.040 which associates the Send-Routing-Info-for-SM with the subsequent Forward-Short-Message messages(s), and store this along with the IMSI of the receiving subscriber. The terminating IP-SM-GW 500 may return only one address, which is of itself, along with the MT Correlation ID as routing information to the originating IP-SM-GW 300.

In steps S14 and S15, the terminating IP-SM-GW 500 may work according to standard encapsulated Short Message termination procedure (see FIG. 3).

S16) The originating IP-SM-GW 300 may deliver (forward) the Short Message (SMS-DELIVER) to terminating IP-SM-GW 500 including the MT Correlation ID received from the terminating IP-SM-GW 500, in the same manner that an SMS-GMSC delivers the short message to an IP-SM-GW (or MSC, SGSN). The terminating IP-SM-GW 500 may receive the short message. The SC address field of the Forward-Short-Message may be set to own IP-SM-GW GT address or to a pre-configured virtual SMSC address.

For optimization purposes, the Forward-Short-Message request may contain a new optional flag, e.g. called noAlertSC. It may be included later on by terminating IP-SM-GW 500 to the Report-SM-Delivery-Status request to indicate to HLR/HSS 400 that there is no SMS-SC to be put to the messages waiting data (MWD) list and no Alert SC request should be sent based on this short message delivery, only the route/domain specific flags should be updated. By default the new flag may not be present and, in case of direct delivery attempt, the originating IP-SM-GW 300 may include it (set to true) in the Forward-Short-Message request.

S17) The terminating IP-SM-GW 500 may perform terminating service authorization based on the stored subscriber data. The IP-SM-GW 500 may check whether the subscriber is authorized to use the short message service (e.g. operator determined barring settings), similar to the authorization performed by MSC/SGSN in case the short message is delivered via CS or PS domain. In addition, the IP-SM-GW 500 may also check whether the subscriber is authorized to use the encapsulated short message delivery via IMS. If the result of service authorization is negative, the IP-SM-GW 500 may not forward the message, and it may return the appropriate error information to the SMS-SC 900 in a failure report. Otherwise, the IP-SM-GW 500 may perform domain selection function to determine the preferred domain for delivering the message according to operator policy and user preferences. The logic for selecting preferred route for message delivery may be a matter of implementation.

S18) If the preferred domain is IMS, the terminating IP-SM-GW 500 may use the TEL-URI associated with the IMSI of the message received for the target UE2 700 to send the short message (SMS-DELIVER, SC Address) encapsulated in an appropriate SIP request towards the S-CSCF of the terminating UE2 700.

S19) The S-CSCF 600 may forward the encapsulated Short Message (SMS-DELIVER, SC Address) to the terminating UE2 700.

S20) The UE2 700 may acknowledge the SIP request.

S21) The S-CSCF 600 of the terminating UE2 700 may forward the acknowledgement of the SIP request to the IP-SM-GW 600 of the subscriber of UE2 700.

Steps S17-S21 may be according to standard encapsulated Short Message termination procedures (see FIG. 3).

S22) The terminating UE2 700 may send a Delivery report (SMS-DELIVER-REPORT) to the S-CSCF 600, including either a positive or a negative acknowledgement to the short message received in step S19.

S23) The S-CSCF 600 of the subscriber may forward the Delivery report to the IP-SM-GW 500 of the terminating UE2 700. It may be ensured that the Delivery report reaches the same IP-SM-GW 500 that forwarded the short message in step S18.

S24) The terminating IP-SM-GW 500 may acknowledge, at the SIP level, the Delivery report to the S-CSCF 600.

S25) The terminating S-CSCF 600 may forward the SIP acknowledgement to the Delivery report to the UE2 700.

S26) The terminating IP-SM-GW 500 may send a Delivery report to the originating IP-SM-GW 300. This is the acknowledgement to the Forward-Short-Message in the SM termination procedure in step S16.

S27) The terminating IP-SM-GW 500 may send a Report-SM-Delivery-Status to the HSS 400. Normally this may trigger the Alert service centre procedure or an update of the message waiting data in the HSS 400, if necessary.

For optimization purposes, also the Report-SM-Delivery-Status request may contain the new (e.g. noAlertSC) optional flag. If the new (e.g. noAlertSC) flag is included in the Forward-Short-Message request received in step S16 and it is set to true, the terminating IP-SM-GW 500 may copy the flag to the Report-SM-Delivery-Status request. In this way it may indicate to the HLR/HSS 400 that there is no SMS-SC to be put to the MWD list and no Alert SC request should be sent based on this short message delivery, only the route/domain specific flags should be updated. By default, the new flag may not be present in the Report-SM-Delivery-Status request.

The originating IP-SM-GW 300 may not send Report-SM-Delivery-Status to the HSS.

S28) According to operator policies, at this point, the originating IP-SM-GW 300 may send a Submit report to S-CSCF 200, encapsulated in an appropriate SIP request.

S29) The S-CSCF 200 may send the Submit report to the originating UE1 100.

S30) The UE1 100 may acknowledge the SIP request.

S31) The originating S-CSCF 200 may forward the acknowledgement of the SIP request to the IP-SM-GW 300 of the originating UE1 100.

The steps S28-S31 may be conditional. Due to timer issues in case of direct delivery service, it may be possible to control by operator when the Submit report is sent to the originating UE1 100.

S32) The originating IP-SM-GW 300 may build SMS-Status-Report and deliver it via the encapsulated short message termination procedure (FIG. 3. and FIG. 4.) if status report was requested by the originating UE1 100.

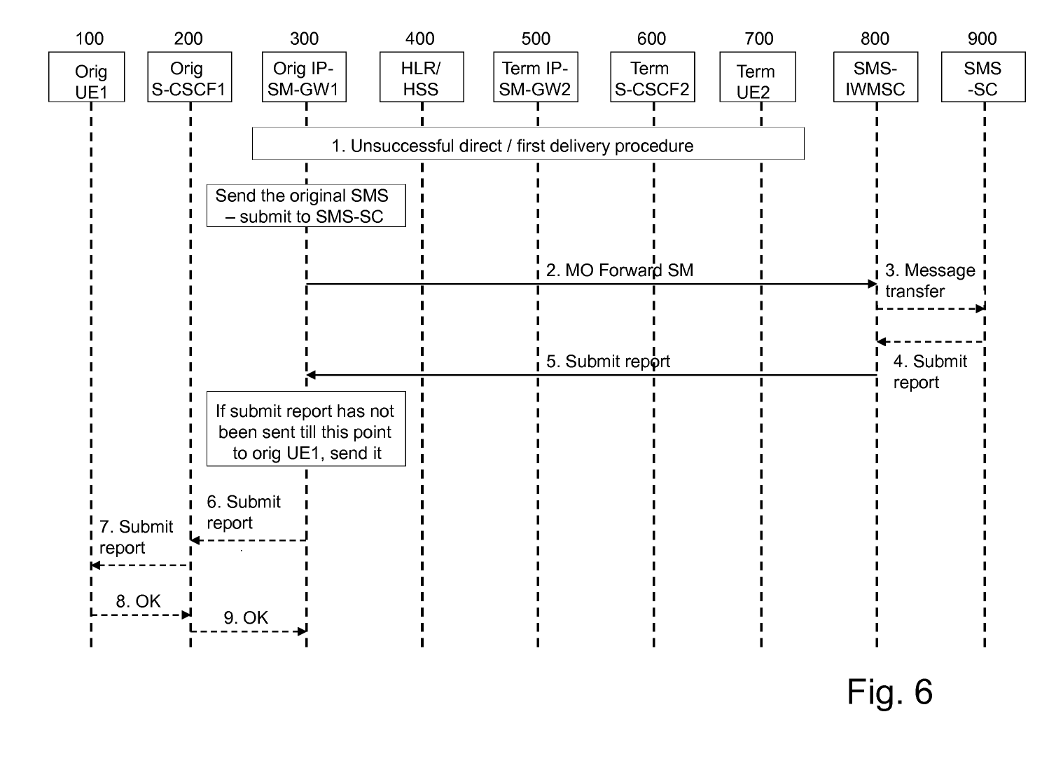

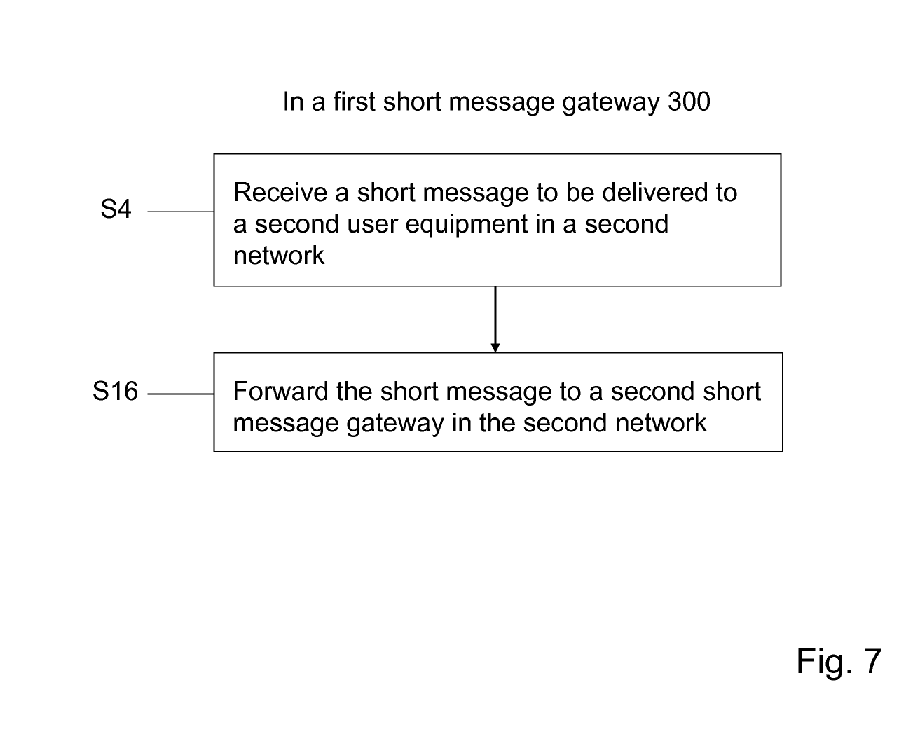

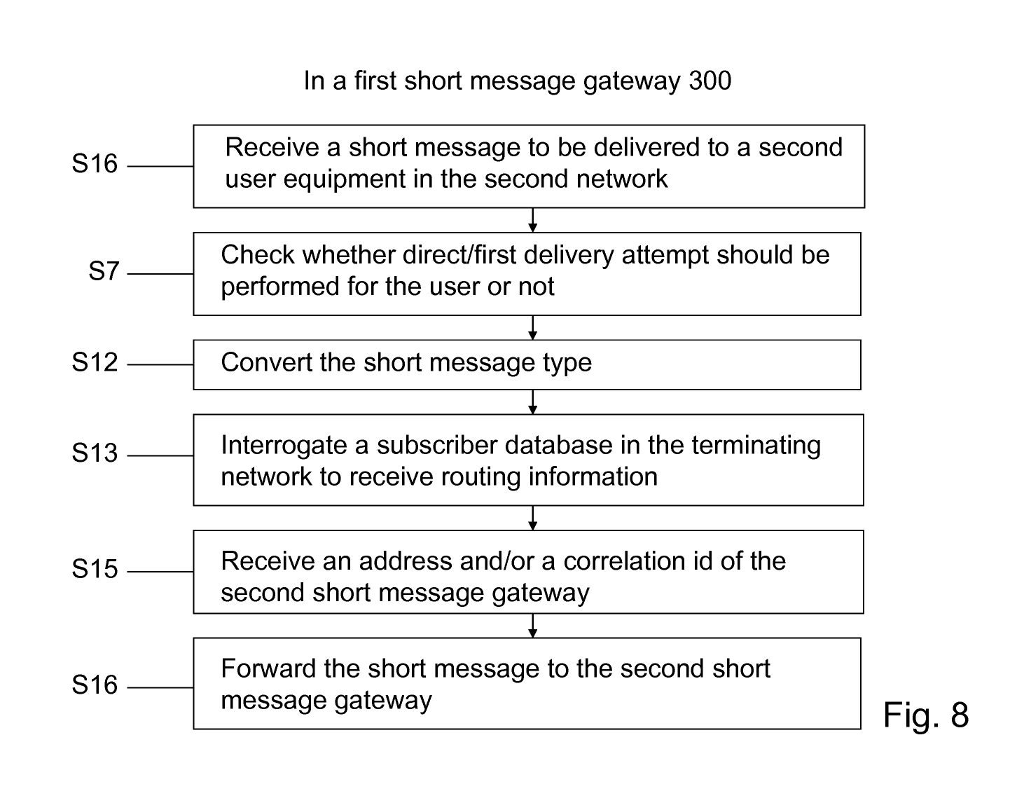

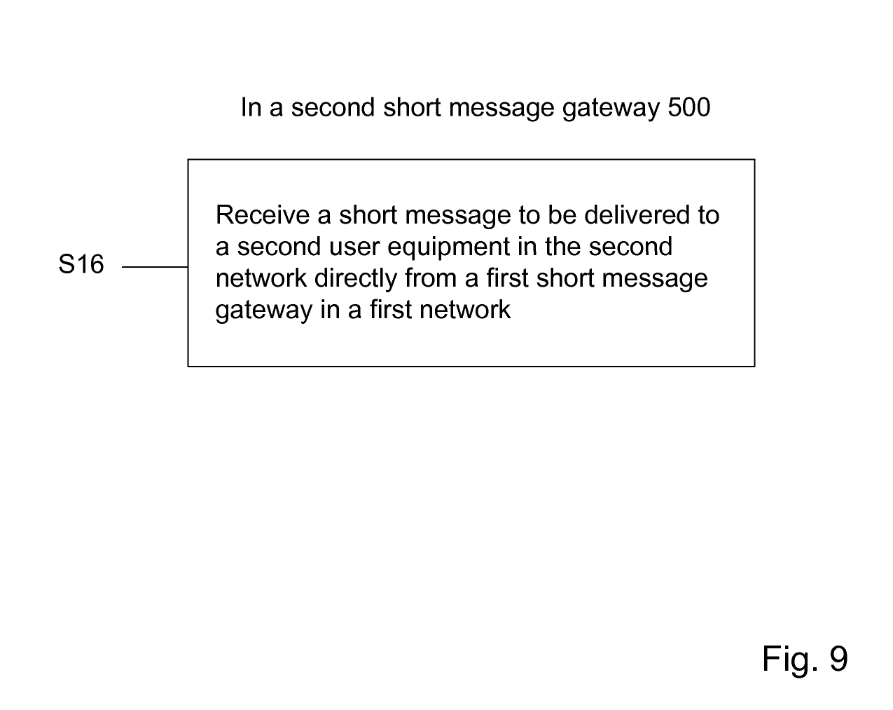

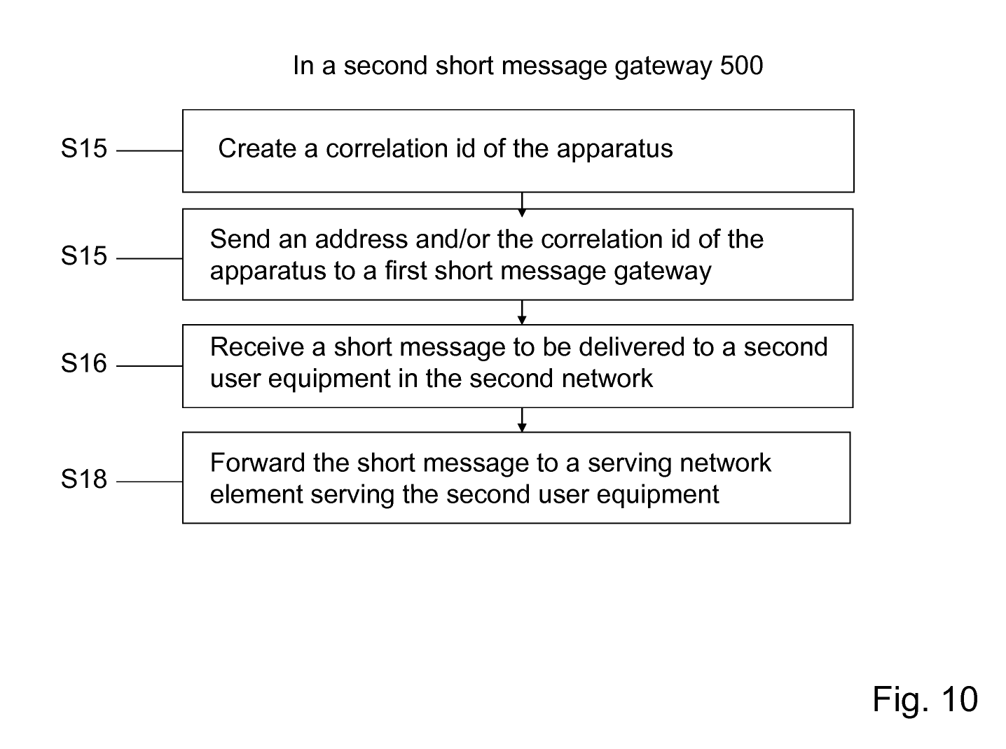

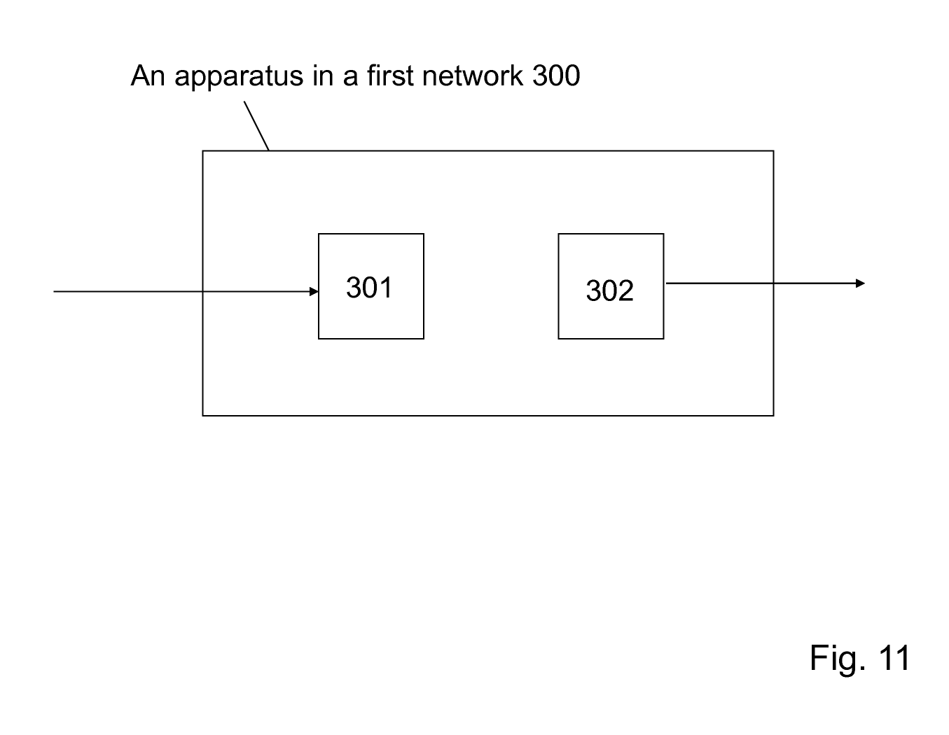

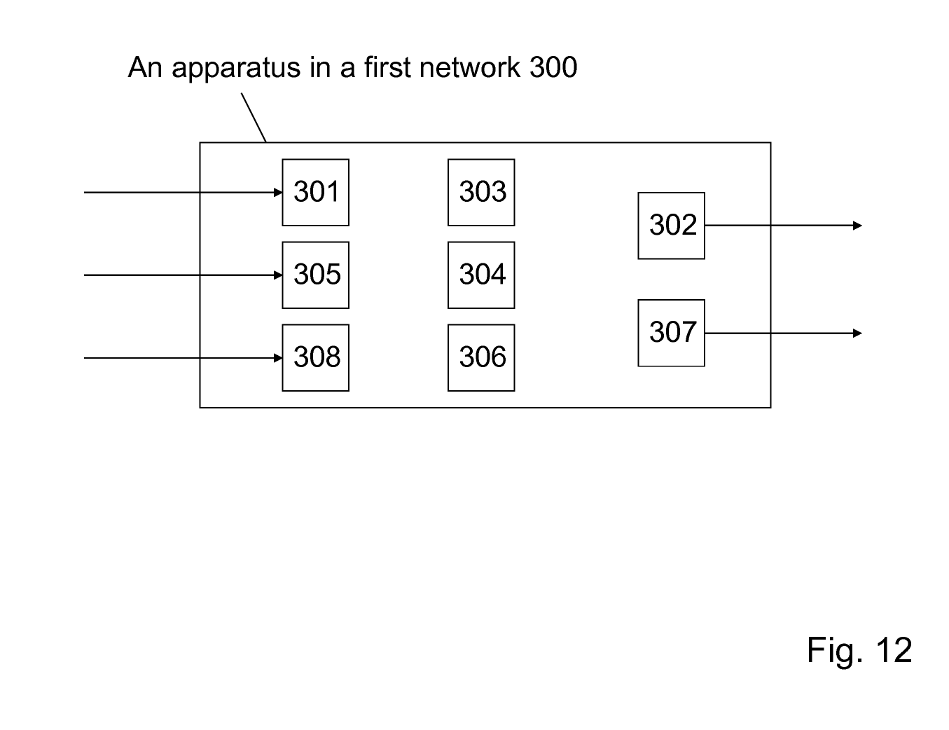

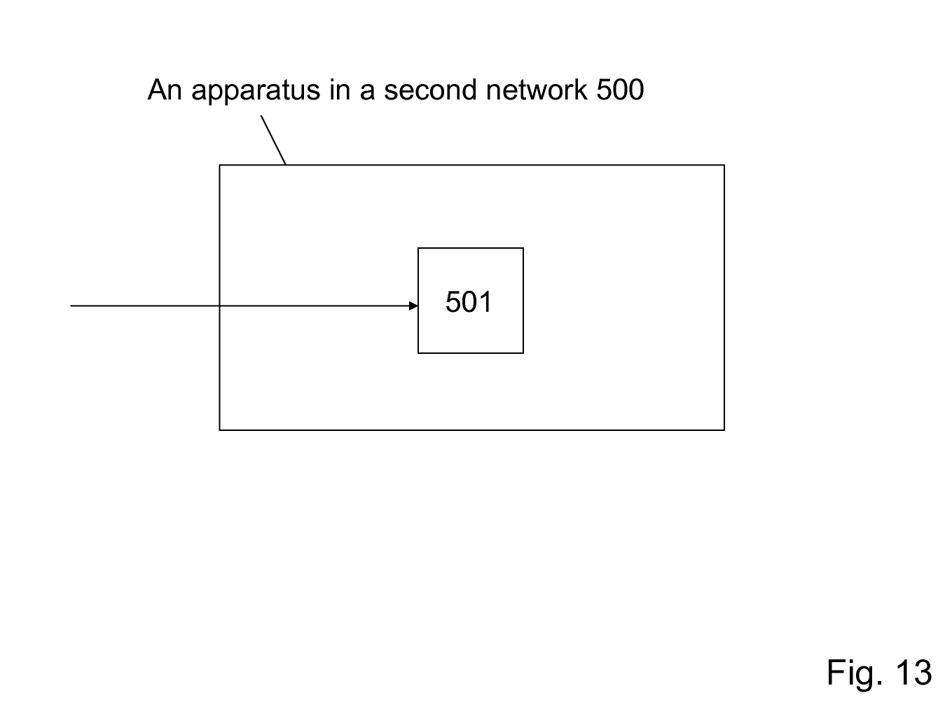

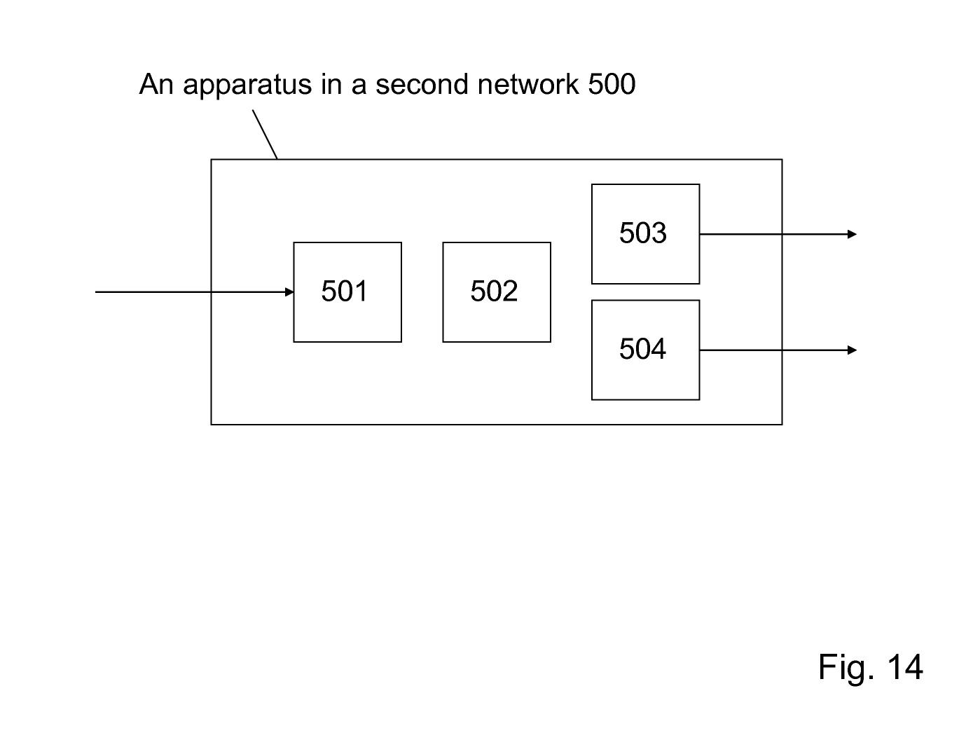

The short message may be forwarded to the SMS-SC 900 only in case of unsuccessful direct/first delivery attempt, e.g. when the B-subscriber (UE2 700) is not available, service authorization fails or delivery failure happens via every valid domain, etc. as in FIG. 6.

The invention further comprises an apparatus 300, e.g. a short message gateway or an IP-SM-GW, in a first network. The apparatus may comprise a first input unit 301, or some other input means (e.g. a receiver), configured to receive a short message to be delivered to a user equipment in a second network, and a first output unit 302/forwarding unit, or some other output means (e.g. a transmitter), configured to forward the short message to a second short message gateway in the second network.

According to some examples of the invention, the apparatus 300 may further comprise a checking unit 303, or some other checking means (e.g. a processor), configured to check if a direct delivery attempt should be performed, an interrogating unit 304, or some other interrogating means (e.g. a processor) configured to interrogate a subscriber database 400 in the second network to retrieve routing information for the user equipment 700 in the second network, a second input unit 305, or some other input means (e.g. a receiver) configured to receive an address and/or a correlation id of the second short message gateway 500 from the second short message gateway 500, a converting unit 306, or some other converting means (e.g. a processor) configured to convert the type of the short message before forwarding it to the second short message gateway 500, a second output unit 307, or some other output means (e.g. a transmitter) configured to send a submit report to the serving network element 200, and a third input unit 308, or some other input means (e.g. a receiver) configured to receive an acknowledgement for a session initiation protocol request.

The invention further comprises an apparatus 500, e.g. a short message gateway or an IP-SM-GW, in a second network. The apparatus may comprise a first input unit 501, or some other input means (e.g. a receiver), configured to receive a short message to be delivered to a user equipment 700 in the second network directly from a first message gateway 300 in a first network, a creating unit 502, or some other creating means (e.g. a processor) configured to create a correlation id of the apparatus 500, first output unit 503, or some other output means (e.g. a transmitter) configured to send an address and/or a correlation id of the apparatus 500 to the first short message gateway 300, and a second output unit 504, or some other output means (e.g. a transmitter) configured to forward the short message to a serving network element 600 serving the user equipment 700 in the second network.

The checking unit 303, the interrogating unit 304, the converting unit 306, and the creating unit 502 may comprise a central processing unit (CPU) or any other means for processing. The input unit 301, 305, 308, 501 may comprise a receiver or any other means for receiving. The output unit 302, 307, 503, 504 may comprise a transceiver or any other means for transmitting. The checking unit 303, the interrogating unit 304, the converting unit 306, the creating unit 502, the input unit 301, 305, 308, 501 and the output unit 302, 307, 503, 504 may exchange information over an internal interface of the corresponding apparatus 300, 500.

The input unit 301, 305, 308, 501 and the output unit 302, 307, 503, 504 of the apparatus 300, 500 may be functionalities running on the processor 303, 304, 306, 502 of the apparatus 300, 500 or may alternatively be separate functional entities or means. They may also be implemented as integral transceivers. The input unit 301, 305, 308, 501 and the output unit 302, 307, 503, 504 may be implemented e.g. as physical transmitters/receivers for transceiving via the air interface, as routing entities for sending/receiving data packets in a PS (packet switched) network, or as any suitable combination thereof.

The checking unit 303, the interrogating unit 304, the converting unit 306, and the creating unit 502 may be configured to process various data inputs and to control input unit 301, 305, 308, 501 and the output unit 302, 307, 503, 504. The apparatus 300, 500 may further comprise a memory. The memory may serve e.g. for storing code means for carrying out e.g. the methods according to the examples of the present invention, e.g. when run on the processor 303, 304, 306, 502.

A term ‘user message’ can be understood to include a message carrying end-to-end content (message) which a sending user wishes to transmit to a receiving user, such as a SIP MESSAGE. Thereby the user message can exclude various other signaling messages transmitted between UEs and network elements.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be possible, while remaining within the scope of the invention.

1.-81. (canceled)

82. A method for user message delivery comprising:
receiving at a first messaging gateway in a first network a user message over internet protocol to be delivered to a second user equipment in a second network; and
forwarding by said first messaging gateway the user message to a second messaging gateway in the second network.

83. A method of claim 82, wherein forwarding the user message comprises forwarding directly from said first messaging gateway to said second messaging gateway.

84. A method of claim 82, further comprising checking by the first messaging gateway if a direct delivery attempt should be performed.

85. A method of claim 82, further comprising interrogating a subscriber database in the second network to retrieve routing information for said second user equipment in the second network.

86. A method of claim 85 further comprising receiving at least one of an address and a correlation id of said second messaging gateway in response to said interrogating.

87. A method of claim 86, wherein receiving at least one of an address and a correlation id of said second messaging gateway comprises receiving from said second messaging gateway.

88. A method of claim 87, wherein forwarding the user message to said second messaging gateway comprises forwarding the user message together with the received correlation id.

89. A method of claim 82, further comprising converting type of the user message before forwarding it to the second messaging gateway.

90. A method of claim 89, wherein type of the user message is converted from SMS-SUBMIT to SMS-DELIVER before forwarding it to the second messaging gateway.

91. A method of claim 82 wherein forwarding the user message to said second messaging gateway comprises forwarding the user message comprising a flag indicating that a short message service centre is not used.

92. A method of claim 82 wherein forwarding the user message to said second messaging gateway comprises forwarding the user message comprising a flag indicating that no alert service centre request should be sent based on the user message delivery.

93. A method of claim 82 wherein receiving said user message comprises receiving from a serving network element serving a first user equipment in the first network.

94. A method of claim 93 further comprising sending a submit report to the serving network element.

95. A method of claim 82 wherein said first messaging gateway comprises an internet protocol short message gateway in the first network.

96. A method of claim 82 wherein said second messaging gateway comprises an internet protocol short message gateway in the second network.

97. A method comprising:
receiving at a second messaging gateway in a second network a user message to be delivered to a second user equipment in the second network;
wherein the user message is received directly from a first message gateway in a first network.

98. A method of claim 97, further comprising, before receiving the user message, sending at least one of an address and a correlation id of said second messaging gateway to said first messaging gateway.

99. A method of claim 97, further comprising forwarding the user message to a serving network element serving the second user equipment in the second network.

100. An apparatus in a first network comprising:
a first input unit configured to receive a user message over internet protocol to be delivered to a second user equipment in a second network; and
a first output unit configured to forward the user message to a second messaging gateway in the second network.

101. An apparatus of claim 100,wherein said first output unit is further configured to forward the user message directly from said first messaging gateway to said second messaging gateway.
